(19) United States
(12) Patent Application Publication
(10) Pub. No.: US 2005/0091950 A1
(43) Pub. Date: May 5, 2005

(54) Power steering fluid reservoir cap with a mist condensing filter

(76) Inventors: Michael S. Weaver, Independence Twp, MI (US); Kevin Newcomer, Lake Orion, MI (US); Randal Race, Ortonville, MI (US); William Wengorovius, Farmington, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/980,202

(22) Filed: Nov. 3, 2004

Related U.S. Application Data
(60) Provisional application No. 60/516,706, filed on Nov. 3, 2003.

(51) Int. Cl. B01D 50/00

(52) U.S. Cl. 55/385.4

(57) ABSTRACT

A cap assembly is provided for a container that defines a reservoir for power steering fluid. The cap assembly has an outer cap adapted to be secured to an open mouth of the container and an inner cap secured to the outer cap and adapted to extend through the open mouth into a neck of the container. The inner cap has an O-ring adapted to seal against a neck of the container. A build-up of air in the reservoir is vented to the outside atmosphere through a passageway in the cap assembly. A filter in the passageway is adapted to pass the air but not to pass a mist emanating from the power steering fluid. The filter condenses the mist for return to the reservoir

### RELATED APPLICATION(S)

This application claims the benefit of U.S. Provisional Patent Application No. 60/516,706, filed Nov. 3, 2003.

### FIELD OF THE INVENTION

This invention relates generally to cap assemblies and more particularly to a cap assembly for a power steering fluid container.

### BACKGROUND OF THE INVENTION

A container which provides a reservoir for power steering fluid typically is closed by a cap. The reservoir must be vented for the escape of air and therefore the cap has vent holes. However, a misting of the power steering fluid collects on the inner surface of the cap and is forced out of the vent holes when pressure builds up in the reservoir during vehicle heat cycles. Prior attempts to prevent power steering fluid leakage have not been successful.

### SUMMARY OF THE INVENTION

In accordance with the present invention, a passageway through the cap assembly is provided for venting a build up of air in the reservoir to the outside atmosphere. A filter in the passageway is adapted to pass the air but not to pass the mist emanating from the power steering fluid. The filter condenses the mist for return to the reservoir. The filter preferably comprises a mesh screen of crossing fibers with openings between fibers on the order of about 1.0 micron in cross section.

More particularly, the cap assembly comprises an outer cap adapted to fit over and to be secured to an open mouth of the container, and an inner cap secured to the outer cap and adapted to extend through the open mouth into a neck of the container. An O-ring on the inner cap is adapted to seal against the neck of the container.

Preferably, the passageway includes a well in the inner cap, a first vent in the inner cap for venting the air and the mist from the reservoir into the well, an outlet from the well covered by the filter, a chamber between the inner and outer cap adapted to receive the air passing from the well through the filter, and a second vent in the inner cap for venting the air from the chamber. The well is adapted to collect the mist condensed by the filter. The first vent provides a return to the reservoir of the mist collected in the well.

One object of this invention is to provide a cap assembly for a container that provides a reservoir for power steering fluid, having the foregoing features and capabilities.

Another object is to provide a cap assembly constructed of a relatively few simple parts and well adapted for the accomplishment of its intended function.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view showing a cap assembly constructed in accordance with the invention separated from a container providing a reservoir for power steering fluid;

FIG. 2 is a perspective view showing the cap assembly, having an outer cap and an inner cap, applied to the container;

FIG. 3 is a sectional view through the cap assembly;

FIG. 4 is a plan view of the inner side of the inner cap;

FIG. 5 is a view partly in elevation and partly in section, taken on the line 5--5 in FIG. 4; and

FIG. 6 is an elevational view of the filter.

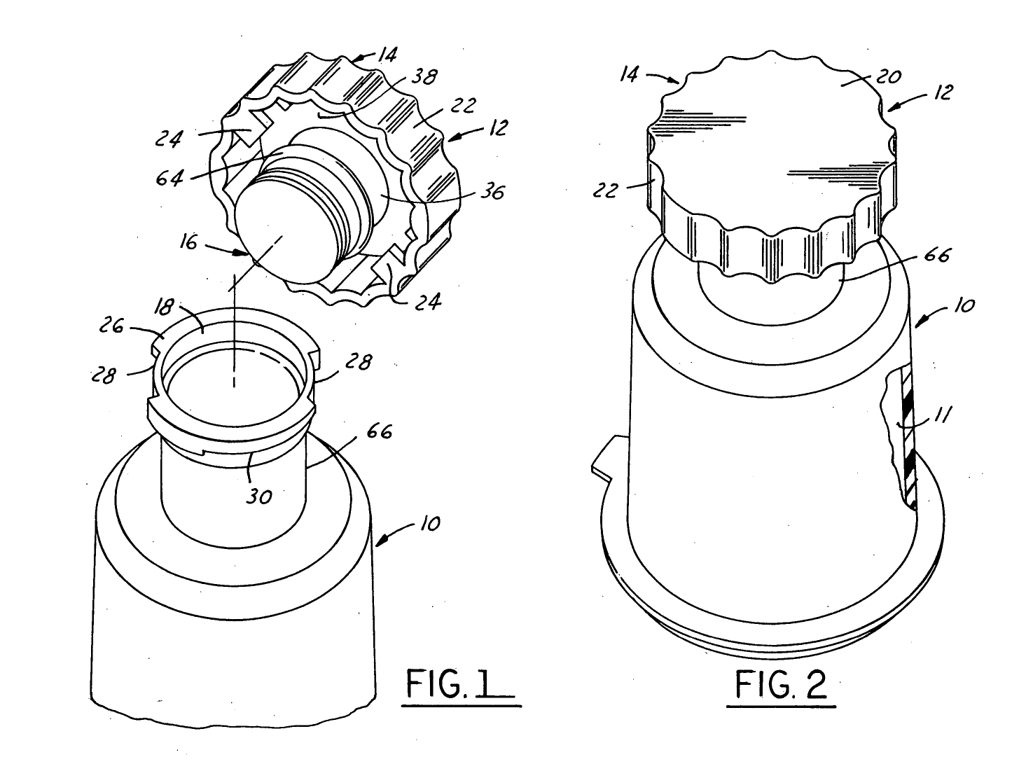

### DETAILED DESCRIPTION OF THE PREFERRED EMBODIMENT

The following description of the preferred embodiment is merely exemplary in nature and is in no way intended to limit the invention, its application, or uses.

Referring now more particularly to the drawings, there is shown a container 10 that provides a reservoir 11 for power steering fluid, which in this case is in liquid form, and a cap assembly 12 for the container. The cap assembly 12 includes an outer cap 14 and an inner cap 16. The cap assembly 12 is adapted to fit over and to be secured to an open mouth 18 of the container 10.

The outer cap 14 has a circular base 20 and a cylindrical side wall 22 extending axially inwardly from the radially outer edge of the base. Diametrically opposite locking tabs 24 extend radially inwardly from the axially inner edge of the side wall 22.

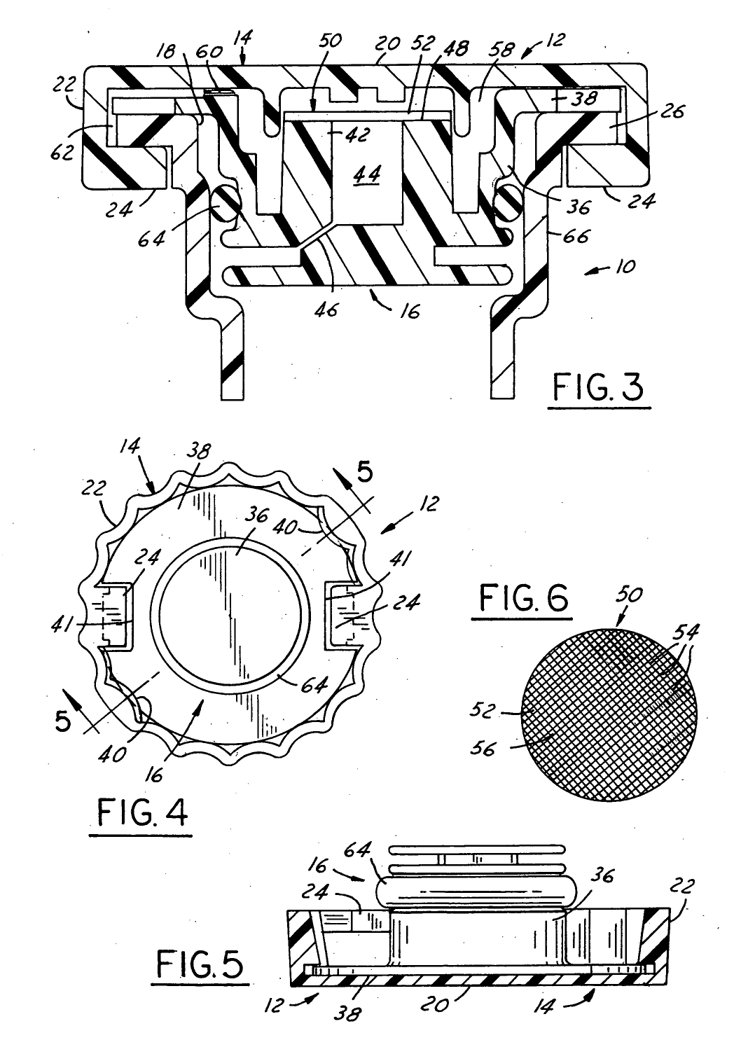

A radially outwardly extending annular flange 26 extends around the open mouth 18 of the container 10. Diametrically opposite notches 28 are cut into the outer edge of the annular flange 26. The annular flange 26 has circumferentially extending ramp surfaces 30 between the notches. The notches 28 are large enough to receive the tabs 24 of the outer cap 14 when the outer cap is applied over the open mouth 18 of the container 10 as shown in FIG. 3. The ramp surfaces 30 between the notches 28 are axially inclined in the same circumferential direction so that after the outer cap 14 is applied over the open mouth of the container 10, the tabs 24, when the outer cap is rotated relative to the container, will ride over the ramp surfaces 30 and secure the outer cap tightly to the container.

The inner cap 16 has a hollow body 36 and a radially outwardly extending annular flange 38 at the axially outer edge of the body. The inner cap 16 is releasably secured to the outer cap 14 by snapping the radially outer edge of the flange 38 under the radially inwardly projecting retainers 40 on the radially inner surface of the side wall 22 of the outer cap. When thus secured to the outer cap 14, the flange 38 of the inner cap 16 presses against the base 20 of the outer cap. Diametrically opposite recesses 41 are provided in the radially outer periphery of the flange 38 to enable the flange to clear the tabs 24 of the outer cap 14 when the inner cap 16 is inserted into the outer cap during assembly.

The inner cap 16 has a tubular tower 42 integral with the body 36. The tower 42 provides a well 44. The inner cap 16 has a vent 46 extending from outside the inner cap into the well. The well 44 has an open outer end 48 which is covered by a filter 50. The filter 50 is secured to the top of the tower across the open outer end 48. The filter comprises a mesh screen 52 of crossing fibers 54 with openings 56 between the fibers on the order of about 1.0 micron in cross section. The fibers are preferably made of a polyester resin. The filter 50 separates the well 44 from a chamber 58 defined by and between the outer cap 14 and the inner cap 16. A vent 60 in the flange 38 extends from the chamber 58 to an annular space 62 around the outer cap 14 which is open to the atmosphere when the cap assembly is applied to the container.

An O-ring 64 carried by the body 36 of the inner cap 16 seals against a neck 66 of the container 10 around a full 360° when the cap assembly 12 is secured to the container as shown in FIG. 3. When the cap assembly 12 is secured on the container, the flange 38 of the inner cap 16 presses down and seals against the flange 26 of the container.

The vent 46, the well 44, the chamber 58, the vent 60 and the space 62 together comprise a passageway for the escape of air from the reservoir.

In use, the cap assembly 12 is applied over the mouth 18 of the container 10 as shown in FIG. 3 with the tabs 24 on the outer cap 14 passing through the notches 28 in the flange 26 of the container and the inner cap 16 extending into the neck 66 of the container. Rotation of the cap assembly 12 relative to the container 10 causes the tabs 24 to ride over the ramp surfaces 30 to secure the cap assembly tightly to the container. The O-ring 64 seals against the neck of the container.

Air in the reservoir 11 will be vented to the atmosphere, passing through the vent 46 into the well 44, from the well 44 through the filter 50 into the chamber 58, from the chamber 58 through the vent 60 into the annular space 62, and from the annular space 62 to the outside atmosphere. The air passes through the filter 50, but any mist emanating from the power steering fluid and moving through the vent 46 into the well 44 will not pass through the filter 50. The filter condenses the mist which collects in the well 44 and returns to the reservoir 11 through the vent 46.

The description of the invention is merely exemplary in nature and, thus, variations that do not depart from the gist of the invention are intended to be within the scope of the invention. Such variations are not to be regarded as a departure from the spirit and scope of the invention.

1. A cap assembly for a container that provides a reservoir for power steering fluid, said cap assembly comprising:
an outer cap adapted to fit over and to be secured to an open mouth of the container,
an inner cap secured to the outer cap and adapted to extend through the open mouth into a neck of the container,
said inner cap having an O-ring seal adapted to seal against the neck of the container,
a passageway through said inner cap and said outer cap for venting a build-up of air in the reservoir to the outside atmosphere, and
a filter in said passageway adapted to pass the air but not to pass a mist emanating from the power steering fluid.

2. The cap assembly of claim 1, wherein said filter condenses the mist for return to the reservoir.

3. The cap assembly of claim 2, wherein said filter comprises a mesh screen of crossing fibers with openings between the fibers on the order of about 1.0 micron in cross-section.

4. The cap assembly of claim 2, wherein said passageway includes a well in the inner cap,
a first vent in the inner cap for venting the air and the mist in the reservoir into the well,
an outlet from said well,
said filter covering the outlet,
a chamber defined by and between said inner cap and said outer cap and adapted to receive the air passing from the well through the filter,
a second vent in the inner cap for venting the air from the chamber,
said well being adapted to collect the mist vented into the well by said first vent and condensed by the filter, and
said first vent providing a return to the reservoir of the mist collected in the well.

5. The cap assembly of claim 4, wherein said filter comprises a mesh screen of crossing fibers with openings between the fibers on the order of about 1.0 micron in cross-section.

6. The cap assembly of claim 5, wherein said fibers are made of a polyester resin.
